(19) United States
(12) Patent Application Publication
(10) Pub. No.: US 2013/0301654 A1
(43) Pub. Date: Nov. 14, 2013

(54) DATA TRANSMISSION APPARATUS AND DATA TRANSMISSION METHOD

(71) Applicant: FUJITSU LIMITED, Kawasaki-shi (JP)

(72) Inventor: Tetsuya YOKOYAMA, Kanazawa (JP)

(73) Assignee: FUJITSU LIMITED, Kawasaki-shi (JP)

(21) Appl. No.: 13/867,558

(22) Filed: Apr. 22, 2013

(30) Foreign Application Priority Data
May 14, 2012 (JP) 2012-110947

(51) Int. Cl. H04L 12/805

(52) U.S. Cl. CPC H04L 47/36
USPC 370/474

(57) ABSTRACT

A reception IF receives a frame from a transmission source. A transmission IF outputs the frame received from the transmission source. A frame counting unit counts a frame having a size not more than a predetermined value, out of the frames output from the transmission IF, for each transmission source. When a transmission source from which a predetermined number of frames having a size not more than the predetermined value are continuously counted is present, a fragment control unit fragments a frame having a size larger than the predetermined value from other transmission source than the transmission source, and outputs the fragmented frame from the output IF.

### CROSS-REFERENCE TO RELATED APPLICATION

This application is based upon and claims the benefit of priority of the prior Japanese Patent Application No. 2012-110947, filed on May 14, 2012, the entire contents of which are incorporated herein by reference.

### FIELD

The embodiments discussed herein are related to a data transmission apparatus and a data transmission method.

### BACKGROUND

An amount of data flowing on a network has rapidly increased thanks to enhanced various network services in recent years. On the other hand, a communication speed and a processing speed have been increasing in a network device such as a data transmission apparatus. In order to promptly process a large amount of data flowing on the network, the data transmission apparatus is requested to use a long frame that handles large data in one frame. For example, a frame with a large size having more than 9000 bytes is sometimes referred to as a jumbo frame.

It is supposed that a short frame and a long frame are used in one network. When the long frame is flown into the network, the process for the short frame has to be in stand-by state during when the long frame is processed. Therefore, the process for the short frame might be delayed. When the process for the short frame is delayed, the arrival time of the short frame to a computer processing the short frame is different, for example. In this case, it is considered that the order of receiving the short frame in the computer is changed. When the order of the received short frame is changed as described above, the computer that receives the short frame might not correctly perform the process.

As a technique for the long frame, there has been conventionally known a technique in which, after a predetermined time has elapsed after an arrival of an ATM (Asynchronous Transfer Mode) cell, a fragmented IP (Internet Protocol) packet that is formed by dividing the ATM cell into a fixed size is generated and transmitted.

Patent Literature 1: Japanese Laid-open Patent Publication No. 2005-303516

However, in the conventional technique in which the fragment process is carried out after a predetermined time has elapsed, the frame might be divided even when the delay is not caused by the long frame. When the frame is fragmented, an overhead might increase due to the addition of information for each of divided frames and an increase in an inter-frame gap. Therefore, when an unnecessary fragment process is carried out, a traffic rate increases, so that additional band might be used, and speed for the data processing might be slow.

### SUMMARY

According to an aspect of an embodiment, a data transmission apparatus includes, a reception unit that receives a frame from a transmission source, an output unit that outputs the frame received from the transmission source, a frame counting unit that counts a frame having a size not more than a predetermined value out of the frames output from the output unit for each transmission source; and a fragment control unit that, when a transmission source from which a predetermined number of frames having the size not more than the predetermined value are continuously counted is present, fragments a frame having a size larger than the predetermined value from the other transmission source than the transmission source, and outputs the fragmented frame from the output unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a data transmission apparatus according to a first embodiment;

FIG. 2 is a view for describing one example of a state of a path;

FIG. 3 is a view illustrating one example of a path connection management table;

FIG. 4 is a view illustrating one example of a counter management table;

FIG. 5 is a view illustrating one example of a priority path determination table;

FIG. 6 is a view illustrating one example of a fragment state management table;

FIG. 7 is a flowchart illustrating an overall flow of a fragment control process;

FIG. 8 is a flowchart for collecting a frame counter value and for determining a transmission state of a frame;

FIG. 9 is a flowchart of determining a priority-path state;

FIG. 10 is a flowchart of deciding the fragment control method;

FIG. 11 is a flowchart of deciding the fragment control state;

FIG. 12 is a sequence diagram of the control of the fragment process by the data transmission apparatus according to the first embodiment;

FIG. 13 is a diagram illustrating a hardware structure of the data transmission apparatus; and

FIG. 14 is a block diagram illustrating a data transmission apparatus according to a second embodiment.

### DESCRIPTION OF EMBODIMENTS

Preferred embodiments of the present invention will be explained with reference to accompanying drawings. The data transmission apparatus and the data transmission method described in the present invention are not limited to the embodiments described below.

### First Embodiment

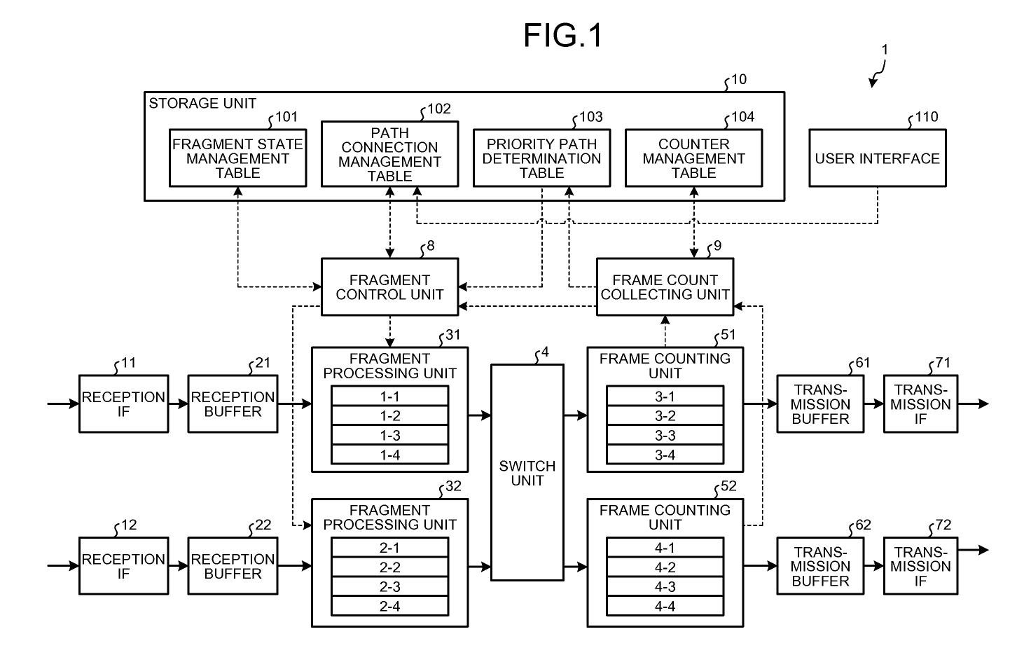

FIG. 1 is a block diagram illustrating a data transmission apparatus according to a first embodiment. As illustrated in FIG. 1, a data transmission apparatus 1 according to the present embodiment includes reception IF (Inter Face) 11 and 12, reception buffers 21 and 22, fragment processing units 31 and 32, a switch unit 4, frame counting units 51 and 52, transmission buffers 61 and 62, and transmission IFs 71 and 72. The data transmission apparatus 1 also includes a fragment control unit 8, a frame count collecting unit 9, a storage unit 10, and a user interface 110.

In the present embodiment, a route through which each frame flows is designated by VLAN (Virtual Local Area Network). Specifically, a passage route is divided for each frame for the designated VLAN, and the data that is designated to use the same VLAN passes through the same route. Each frame includes identification information of the VLAN. The route designated by the VLAN in the data transmission apparatus 1 is referred to as a path below. In other words, the frame that is designated to use the same VLAN passes through the same path. In the present embodiment, the route of the frame transmitted by the VLAN is divided. However, other dividing process may be employed. For example, a frame output from an apparatus may pass through a different route, i.e., different path.

The reception IFs 11 and 12 are interfaces receiving a frame externally input. The reception IF 11 receives the externally input frame, and outputs the frame to the reception buffer 21. The reception IF 12 receives the externally input frame, and outputs the frame to the reception buffer 22.

The reception buffer 21 stores the frame received from the reception IF 11. The reception buffer 22 stores the frame received from the reception IF 12.

The fragment processing unit 31 reads the frame stored in the reception buffer 21 one by one. The fragment processing unit 31 processes the frame for each user traffic, i.e., for each VLAN, in the present embodiment. Each of numerals “1-1” to “1-4” in the fragment processing unit 31 in FIG. 1 indicates a processing function for each VLAN in the fragment processing unit 31. In “1-1” to “1-4”, the former numeral indicates the interface from which the frame is received, and the latter numeral indicates the VLAN. When the former numeral is “1”, the interface is the reception IF 11, and when the former numeral is “2”, the interface is the reception interface IF 12. For example, “1-1” means that data having VLAN identifier of 100 and input from the reception IF 11 is processed. In each of “1-1” to “1-4”, the frame input from the reception IF 11 and using different VLAN is processed. The way of the process to the frame by the fragment processing unit 31 will be described next.

The fragment processing unit 31 accepts an instruction of setting a fragment process for executing a fragment process, and an instruction of canceling the fragment process for stopping the execution of the fragment from the fragment control unit 8 for each VLAN, i.e., for each path.

The fragment processing unit 31 executes the fragment process to a frame having a length longer than a prescribed length (hereinafter referred to as a “long frame”), out of frames that pass through the path to which the instruction of setting the fragment process is issued. In this case, the fragment processing unit 31 does not execute the fragment process to the frame having a size not more than the prescribed length (hereinafter referred to as a “short frame” below). The fragment processing unit 31 then outputs the short frame and the jumbo frame to which the fragment process is executed to the switch unit 4. For example, it is described below that the fragment processing unit 31 processes the frame, which is received by the reception IF 11 and passes through the path having the VLAN identification number of 100, in “1-1”. When the fragment control unit 8 issues an instruction of the fragment process to the frame that is received by the reception IF 11 and passes through the path having the VLAN identification number of 100, the fragment processing unit 31 executes the fragment process to the long frame passing through the “1-1”, and outputs the resultant.

For the frame passing through the path to which the fragment instruction is not issued, and the path to which the instruction of canceling the fragment process is issued, the fragment processing unit 31 reads the short frame and the long frame from the reception buffer 21, and outputs these frames as they are to the switch unit 4.

The fragment processing unit 32 reads the frame from the reception buffer 21, executes the fragment process to the frame passing through each path in accordance with the instruction from the fragment control unit 8, and outputs the resultant to the switch unit 4. Each of numerals “2-1” to “2-4” in the fragment processing unit 32 in FIG. 1 indicates a processing function for each VLAN in the fragment processing unit 32. The detail of the operation of the fragment processing unit 32 is the same as that of the fragment processing unit 31, so that the description will not be repeated here.

The switch unit 4 receives the frame input from the fragment processing units 31 and 32. The switch unit 4 then outputs the received frame to the frame counting unit 51 or 52 according to the setting of VLAN. For example, VLAN 100 includes the path through a later-described “3-1” in the frame counting unit 51 via the “1-1” in the fragment processing unit 31, the switch unit 4 outputs the frame received from the “1-1” in the fragment processing unit 31 to the “3-1” in the frame counting unit 51.

The frame counting units 51 and 52 have a short-frame counter and a long-frame counter. The frame counting units 51 and 52 count the number of the received frames.

The frame counting unit 51 receives the frame input from the switch unit 4 for each VLAN, i.e., for each path. Each of numerals “3-1” to “3-4” in the frame counting unit 51 in FIG. 1 indicates a processing function for each VLAN in the frame counting unit 51. In “3-1” to “3-4”, the former numeral indicates the interface from which the frame is received, and the latter numeral indicates the VLAN. When the former numeral is “3”, the interface is the transmission interface IF 71, and when the former numeral is “4”, the interface is the transmission IF 72. For example, “3-1” means that data having VLAN identifier of 100 and output from the transmission IF 71 is processed. In each of “3-1” to “3-4”, the frame output from the transmission IF 71 and using different VLAN is processed. The way of the process to the frame by the frame counting unit 51 will be described next.

The frame counting unit 51 counts the number of the short frames and the number of the long frames in the frames received for each path by using the respective counters. The frame counting unit 51 outputs the received frame to the transmission buffer 61.

Similarly, the frame counting unit 52 counts the number of the short frames and the number of the long frames in the frames received from the switch unit 4. The frame counting unit 52 outputs the received frame to the transmission buffer 62.

The transmission buffer 61 stores the frames received from the frame counting unit 51. The transmission buffer 62 acquires and stores the frames received from the frame counting unit 52.

The transmission IF 71 reads the frame stored in the transmission buffer 61, and outputs the frame to an external apparatus to which line is connected. The transmission IF 72 reads the frame stored in the transmission buffer 62, and outputs the frame to an external apparatus to which a line is connected.

The storage unit 10 stores a fragment state management table 101, a path connection management table 102, a priority path determination table 103, and a counter management table 104. Each table will be described later in detail.

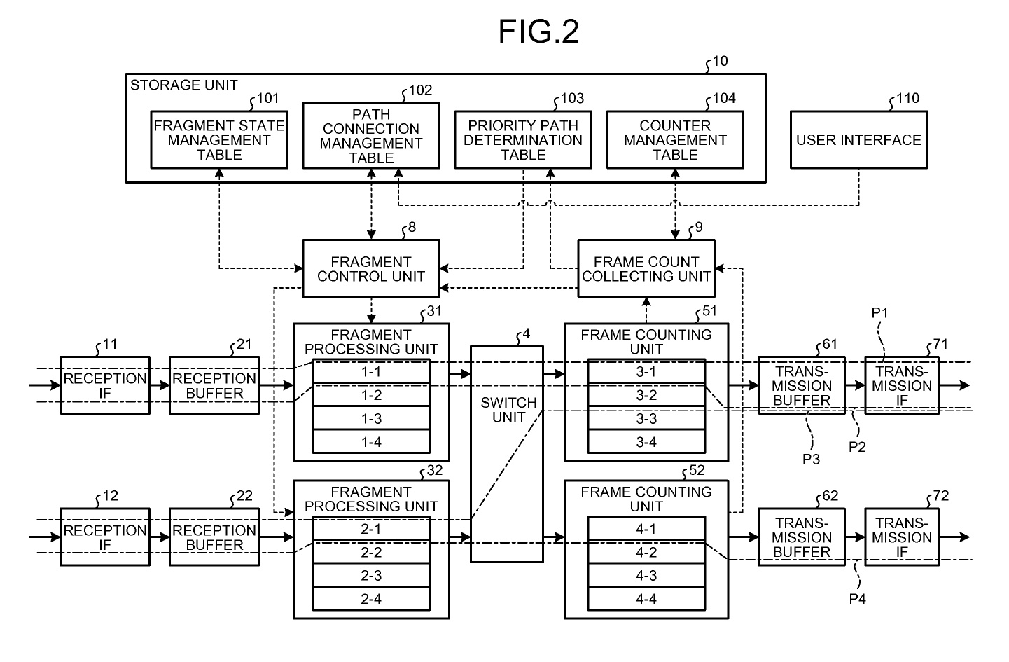

The condition where the path is connected as illustrated in FIG. 2 will be described below. FIG. 2 is a view for describing one example of a state of the path.

In FIG. 2, a path P1 is a path through the reception IF 11, the reception buffer 21, the “1-1” in the fragment processing unit 31, the switch unit 4, the “3-1” in the frame counting unit 51, the transmission buffer 61, and the transmission IF 71. A path P2 is a path through the reception IF 11, the reception buffer 21, the “1-2” in the fragment processing unit 31, the switch unit 4, the “3-2” in the frame counting unit 51, the transmission buffer 61, and the transmission IF 71. A path P3 is a path through the reception IF 12, the reception buffer 22, the “2-1” in the fragment processing unit 32, the switch unit 4, the “3-3” in the frame counting unit 51, the transmission buffer 61, and the transmission IF 71. A path P4 is a path through the reception IF 12, the reception buffer 22, the “2-2” in the fragment processing unit 32, the switch unit 4, the “4-1” in the frame counting unit 52, the transmission buffer 62, and the transmission IF 72.

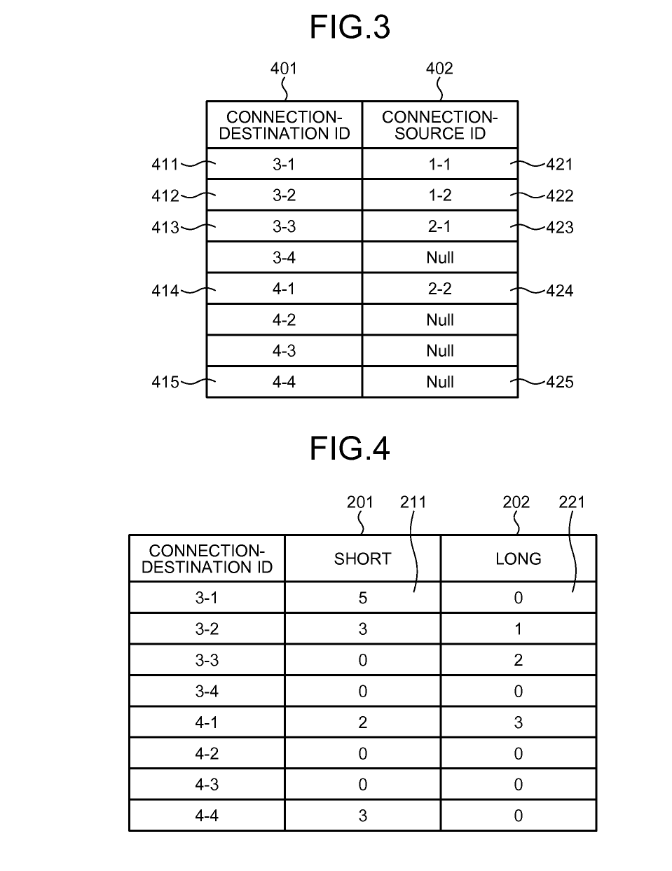

An operator registers the association between the destination of the path and the source of the path to the path connection management table 102 by using the user interface 110. The destination of the path is indicated by the interface that receives the frame and the VLAN identifier. Specifically, the destination of the path corresponds one-to-one with “1-1” to “1-4” in the fragment processing unit 31, and “2-1” to “2-4” in the fragment processing unit 32. The source of the path is indicated by the interface that outputs the frame and the VLAN identifier. Specifically, the destination of the path corresponds one-to-one with “3-1” to “3-4” in the frame counting unit 51, and “4-1” to “4-4” in the frame counting unit 52. As illustrated in FIG. 3, the setting input by the operator by using the user interface 110 is registered on the path connection management table 102. FIG. 3 is a view illustrating one example of the path connection management table. FIG. 3 illustrates the state of the path illustrated in FIG. 2. In the path connection management table 102, the connection-source ID (Identification) is registered on a row 401, and the connection-destination ID is registered on a row 402. The source of the path corresponds one-to-one with “1-1” to “1-4” in the fragment processing unit 31, and “2-1” to “2-4” in the fragment processing unit 32. Therefore, the connection-source ID of the path is indicated by using “1-1” to “1-4” and “2-1” to “2-4”. The destination of the path corresponds one-to-one with “3-1” to “3-4” in the frame counting unit 51, and “4-1” to “4-4” in the frame counting unit 52. Therefore, the connection-destination ID of the path is indicated by using “3-1” to “3-4” and “4-1” to “4-4”. It is supposed that the source of the connection and the destination of the connection of the path are indicated by using these numerals in the description below. Since the path P1 passes through “1-1” and “3-1”, the connection-source ID of the path P1 is “1-1”, and the connection-destination ID is “3-1”. Therefore, “1-1” is written as the connection-source ID on a column 421 that corresponds to a column 411 in which “3-1” is written as the connection-destination ID. Since the path P2 passes through “1-2” and “3-2”, the connection-source ID of the path P2 is “1-2”, and the connection-destination ID is “3-2”. Therefore, “1-2” is written as the connection-source ID on a column 422 that corresponds to a column 412 in which “3-2” is written as the connection-destination ID. Since the path P3 passes through “2-1” and “3-3”, the connection-source ID of the path P3 is “2-1”, and the connection-destination ID is “3-3”. Therefore, “2-1” is written as the connection-source

ID on a column 423 that corresponds to a column 413 in which “3-3” is written as the connection-destination ID. Since the path P4 passes through “2-2” and “4-1”, the connection-source ID of the path P4 is “2-2”, and the connection-destination ID is “4-1”. Therefore, “2-2” is written as the connection-source ID on a column 424 that corresponds to a column 414 in which “4-1” is written as the connection-destination ID. A path does not pass through “2-4” in the fragment processing unit 32, for example. Therefore, “Null” is written on a column 425 that indicates the connection-source ID and that corresponds to a column 415 in which “2-4” is written as the connection-destination ID. Similarly, “Null” is written on the column of the other connection-source ID corresponding to the connection-destination ID through which any path does not pass.

The frame count collecting unit 9 has a timer. The frame count collecting unit 9 preliminarily stores a cycle for collecting a frame count value. The frame count collecting unit 9 counts an elapsed time by the timer, and determines whether or not the cycle for collecting the frame count value, which is the number of the frames counted respectively by the frame counting units 51 and 52, has come. When the cycle for collecting the frame count value has come, the frame count collecting unit 9 acquires the number of the short frames and the number of the long frames for each VLAN from the frame counting units 51 and 52. The frame count collecting unit 9 then registers the acquired number of the short frames and the acquired number of the long frames into the counter management table 104 for each VLAN as illustrated in FIG. 4. FIG. 4 is a view illustrating one example of the counter management table.

As illustrated in FIG. 4, the counter management table 104 has a row 201 (indicated as “short” in FIG. 4) indicating the number of the short frames, and a row 202 (indicated as “long” in FIG. 4) indicating the number of the long frames in association with the connection-destination ID. For example, in FIG. 4, 5 is written on a column 211 indicating the number of the short frames in the path having the connection-destination ID of “3-1”, and 0 is written on a column 221 indicating the number of the long frames. Specifically, in FIG. 4, five short frames are flown, and no long frame is flown on the path having the connection-destination ID of “3-1”. Here, it is described that the frame count collecting unit 9 collects each frame count value as illustrated in the counter management table 104 in FIG. 4.

Next, the frame count collecting unit 9 checks whether or not the number of the short frames is equal to or larger than a prescribed number, and the number of the long frames is 0 in each path by referring to the counter management table 104 on which the frame count values collected by itself are registered.

The frame count collecting unit 9 sets “TRUE” as the determination result of the transmission state of the path in which the number of the short frames is three that is not less than the threshold value and the number of the long frames is zero in the priority path determination table 103. The frame count collecting unit 9 sets “FALSE” as the determination result of the transmission state of the path in which the number of the short frames is less than the threshold value and the number of the long frames is one or more in the priority path determination table 103. With this process, the frame count collecting unit 9 creates the priority path determination table 103 as illustrated in FIG. 5. FIG. 5 is a view illustrating one example of the priority path determination table. As illustrated in FIG. 5, the priority path determination table 103 includes a row 301 indicating the determination result of the transmission state corresponding to the connection-destination ID. For example, it is supposed that the threshold value of the number of the short frames is set as three. Since the path having the connection-destination ID of 3-1 has five short frames and no long frame in FIG. 4, the frame count collecting unit 9 sets TRUE on a column 311 corresponding to the connection-destination ID 3-1. Since the paths having the connection-destination ID of 3-2, 3-3, and 4-1 have one or more long frames, the frame count collecting unit 9 sets FALSE on columns 312, 313, and 314 corresponding to the connection-destination IDs 3-2, 3-3, and 4-1 respectively. Any path does not pass through the other connection-destination IDs, so that the frame count collecting unit 9 does not set a value.

When finishing the creation of the priority path determination table 103, the frame count collecting unit 9 requests the control of the fragment process to the fragment control unit 8.

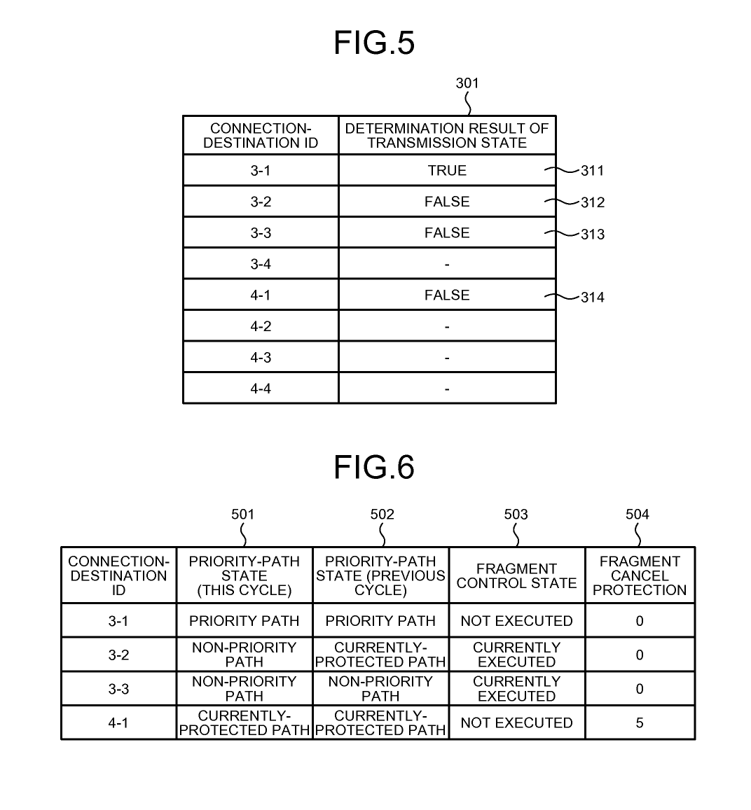

When receiving the request of the control of the fragment process from the frame count collecting unit 9, the fragment control unit 8 acquires the determination result of the transmission state of each path from the priority path determination table 103. The fragment control unit 8 also acquires a fragment state management table 101 as illustrated in FIG. 6. FIG. 6 is a view illustrating one example of the fragment state management table.

The fragment state management table 101 has a row 501 indicating a priority-path state in this cycle corresponding to the connection-destination ID. The result of the priority-path state, which is determined in this cycle by the fragment control unit 8, of the path corresponding to the connection-destination ID is registered in the priority-path state in this cycle in the row 501. In the present embodiment, the priority-path state includes three types, which are a priority path, non-priority path, and a currently-protected path. The priority path means the path in which the fragment process is executed in the other path, when there is other path using the same transmission interface. On the contrary, the non-priority path means the path in which the fragment process is executed therein, when there is the priority path in the other paths using the same transmission interface. The currently-protected path means the path in which, when the priority path is changed to the non-priority path, the fragment process is continued in the other path for a predetermined period. The fragment state management table 101 also has a row 502 indicating the priority-path state in the previous cycle. The determination result of the priority-path state in the previous cycle is registered in the row 502. The fragment state management table 101 also has a row 503 indicating the fragment control state that indicates whether the fragment process is set or not to the path corresponding to the connection-destination ID. The fragment state management table 101 also has a row 504 indicating whether or not a fragment cancel protection, which holds the cancel of the fragment process for a fixed period, is set. The fragment cancel protection will be described in detail below.

The fragment control unit 8 determines the priority-path state in this cycle for each path, and decides the fragment control method in accordance with the priority-path state of the path included in each transmission interface. The fragment control unit 8 decides the fragment control state of each path according to the decided fragment control method. The fragment control unit 8 issues an instruction of setting or canceling the fragment process to the fragment processing units 31 and 32 in accordance with the decided fragment control state.

The determination of the priority-path state will be described in detail. When receiving the request of the fragment control from the frame count collecting unit 9, the fragment control unit 8 selects any one of all paths. The fragment control unit 8 then determines whether the fragment control state is currently executed or not in the selected path from the fragment control state in the fragment state management table 101. When the fragment control state is currently executed in the selected path, the fragment control unit 8 keeps the priority-path state and the value of the fragment cancel protection of the selected path. Here, the value of the fragment cancel protection becomes “0”. The case where the value of the fragment cancel protection is “0” means that the fragment cancel protection is not executed in this path.

On the other hand, when the fragment control state is not currently executed in the selected path, the fragment control unit 8 determines whether the determination result of the transmission state of the selected path is TRUE or not from the priority path determination table 103. When the determination result of the transmission state of the selected path is TRUE, the fragment control unit 8 sets the priority-path state of the selected path in this cycle as the priority path, and also sets the fragment cancel protection to “0”.

On the other hand, when the determination result of the transmission state of the selected path is FALSE, the fragment control unit 8 determines which the priority-path state of the selected path in the previous cycle is, the priority path, the non-priority path, or the currently-protected path. When the priority-path state of the selected path in the previous cycle is the non-priority path, the fragment control unit 8 keeps the priority-path state and the value of the fragment cancel protection of the selected path.

When the priority-path state of the selected path in the previous cycle is the priority path, the fragment control unit 8 sets the priority-path state of the selected path in this cycle to the currently-protected path, and also sets the value of the fragment cancel protection to the number of the protection set beforehand, e.g., “5” in the present embodiment. When the priority path in the previous cycle is suddenly changed to the non-priority path, the fragment process in the other paths might immediately be canceled in case where the transmission of the short frame is delayed a little, or in case where a few long frames are mixed. In this case, even if the continuous transmission of the short frames is soon started again, the period when the fragment process is not executed in the other paths might be generated. Therefore, delay might be caused in the path in which the delay is not permitted. Accordingly, when the priority-path state is changed from the priority path to the non-priority path, the current state is maintained for a certain period, e.g., 5 cycles in the present embodiment. When the continuous transmission of the short frames is again started in this period, the fragment process can be continued, and the delay of the short frames is avoided.

When the priority-path state of the selected path in the previous cycle is the currently-protected path, the fragment control unit 8 determines whether the value of the fragment cancel protection of the selected path in the fragment state management table 101 is 0 or not. When the value of the fragment cancel protection is 0, the fragment control unit 8 sets the priority-path state of the selected path in this cycle to the non-priority path, and keeps the value of the fragment cancel protection as 0. On the other hand, when the value of the fragment cancel protection is not 0, the fragment control unit 8 keeps the priority-path state of the selected path in this cycle as the currently-protected path, and decrements the value of the fragment cancel protection by 1.

The fragment control unit 8 registers the decided priority-path state and the value of the fragment cancel protection of the selected path to the fragment state management table 101. The fragment control unit 8 carries out the determination of the priority-path state described above for all paths.

The decision of the fragment control method will next be described in detail. When determining the priority-path state of all paths, the fragment control unit 8 temporarily sets “cancel” for the fragment control method in the transmission IFs 71 and 72, thereby initializing the fragment control method of each transmission interface.

The connection-destination ID includes information indicating from which transmission interface the frame is output. Therefore, the fragment control unit 8 extracts the paths using the same transmission interface by use of the connection-destination ID. In the present embodiment, the fragment control unit 8 extracts the paths having the same former numeral in the connection-destination ID as the paths using the same transmission interface. Then, the fragment control unit 8 selects one transmission interface, and decides the fragment control method for this transmission interface. The case for the transmission IF 71 will be described below.

The fragment control unit 8 selects any one of the paths using the transmission IF 71. The fragment control unit 8 determines the priority-path state of the selected path by referring to the current priority-path state in the fragment state management table 101. When the selected path is the priority path, the fragment control unit 8 decides the fragment control method for the transmission IF 71 as “set”. In this case, the fragment control method for the transmission IF 71 is decided as “set”.

When the selected path is the currently-protected path, the fragment control unit 8 temporarily sets the fragment control method for the transmission IF 71 as “hold”. When the selected path is the non-priority path, the fragment control unit 8 holds “cancel” of the fragment control method for the transmission IF 71. When the selected path is the currently-protected path or the non-priority path, the fragment control unit 8 selects one of the paths that use the transmission IF 71 and that are not used for the other determination, and repeats the above-mentioned determination. When there is the priority path during the determination, the fragment control unit 8 decides the fragment control method for the transmission IF 71 as “set”. On the other hand, in the case of the currently-protected path and the non-priority path, the fragment control unit 8 decides the fragment control method for the transmission IF 71 as “hold”. In the case of the non-priority path, the fragment control unit 8 decides the fragment control method for the transmission IF 71 as “cancel”.

The decision of the fragment control state for each path will next be described in detail. The fragment control unit 8 selects the transmission interface, and determines whether the fragment control is executed or not for each path included in the transmission interface. The case where the transmission IF 71 is selected as the transmission interface will be described below.

Firstly, the fragment control unit 8 acquires the connection-source ID corresponding to the connection-destination ID of each path included in the transmission IF 71 from the path connection management table 102.

When the fragment control method for the transmission IF 71 is “hold”, the fragment control unit 8 keeps the fragment control state of the process corresponding to the connection-source ID and executed by the fragment processing units 31 and 32.

When the fragment control method for the transmission IF 71 is “set”, the fragment control unit 8 selects one of the paths using the transmission IF 71. The fragment control unit 8 then acquires the priority-path state of the selected path from the fragment state management table 101. When the selected path is the priority path or the currently-protected path, the fragment control unit 8 keeps the fragment control state of the process corresponding the connection-source ID of the selected path and executed by the fragment processing unit 31 or 32, and with this state, executes the determination of the next path. On the other hand, when the selected path is the non-priority path, the fragment control unit 8 issues an instruction of setting the fragment process for the process corresponding to the connection-source ID of the selected path to the fragment processing unit 31 or 32. The fragment control unit 8 repeats the decision of the fragment control state described above for all paths using the transmission IF 71.

When the fragment control method for the transmission IF 71 is “cancel”, the fragment control unit 8 selects one of the paths using the transmission IF 71. The fragment control unit 8 then acquires the priority-path state of the selected path from the fragment state management table 101. When the fragment process is not executed in the selected path, the fragment control unit 8 keeps the fragment control state of the process executed by the fragment processing unit 31 or 32 corresponding to the connection-source ID of the selected path. The fragment control unit 8 then executes the determination for the next path. On the other hand, when the fragment process is currently executed in the selected path, the fragment control unit 8 issues an instruction of canceling the fragment process in the process corresponding to the connection-source ID of the selected path to the fragment processing unit 31 or 32. The fragment control unit 8 repeats the decision of the fragment control state described above for all paths using the transmission IF 71.

The fragment control unit 8 registers the decided fragment control state for all paths to the fragment control state in the fragment state management table 101.

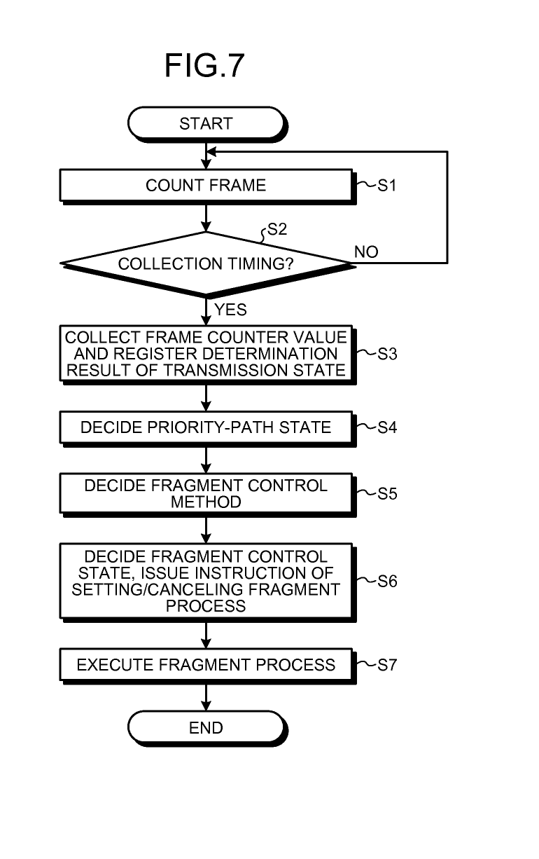

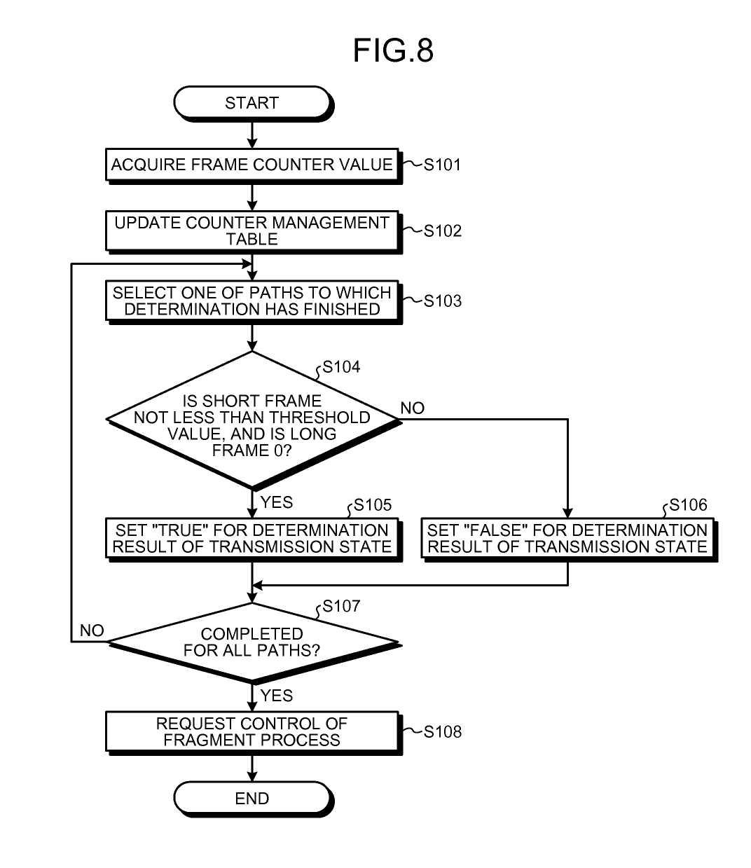

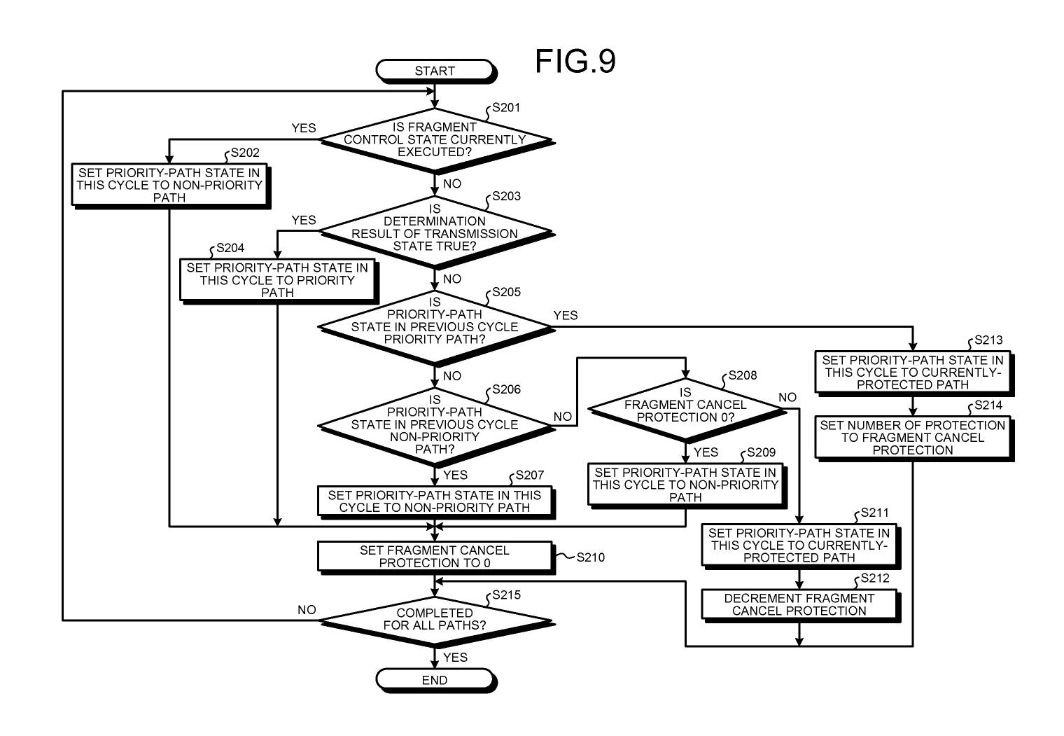

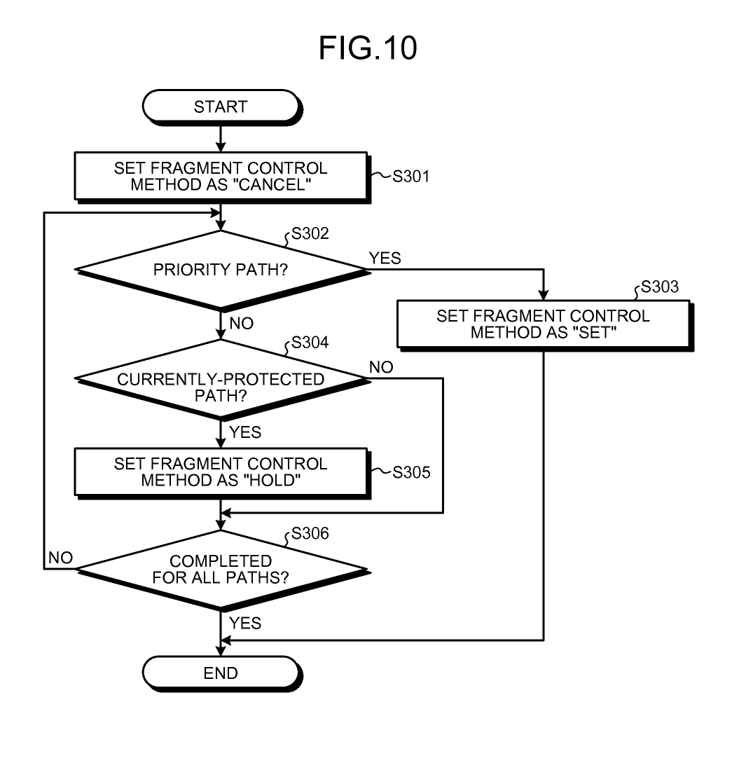

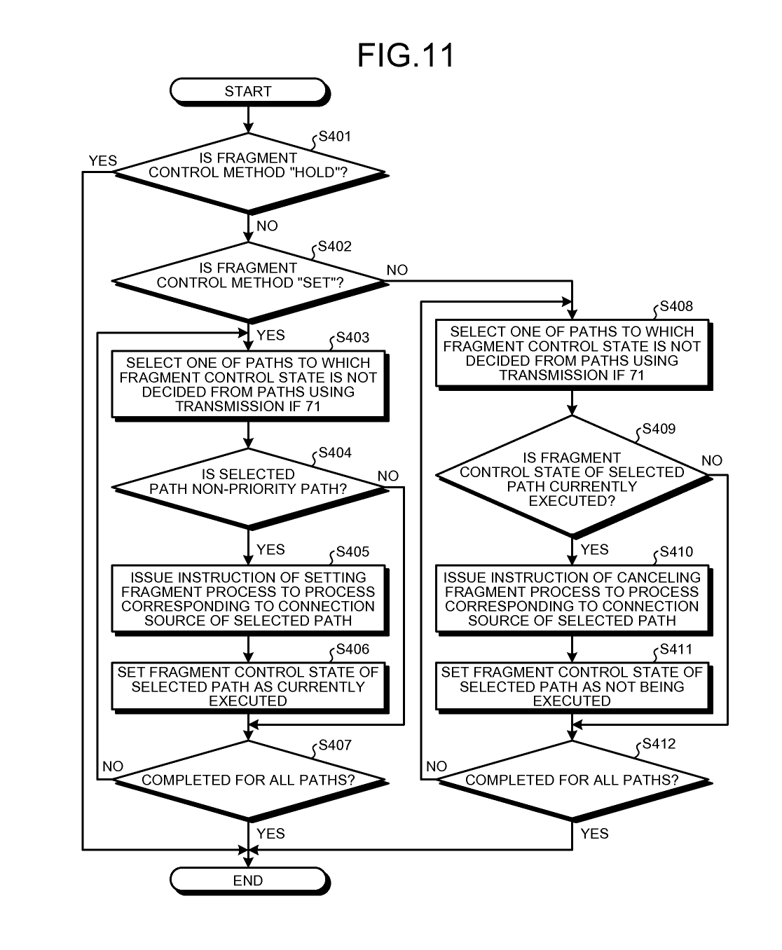

Subsequently, the flow of the fragment control process in the data transmission apparatus 1 according to the present embodiment will be described with reference to FIGS. 7 to 11. FIG. 7 is a flowchart illustrating an overall flow of the fragment control process. FIG. 8 is a flowchart for collecting the frame counter value and for determining the transmission state of the frame. FIG. 9 is a flowchart of determining the priority-path state. FIG. 10 is a flowchart of deciding the fragment control method. FIG. 11 is a flowchart of deciding the fragment control state.

The overall outline of the fragment control process will be described with reference to FIG. 7. The frame counting units 51 and 52 count the number of the short frames and the number of the long frames for each path (step S1). The frame count collecting unit 9 determines whether a collection timing, which is periodically repeated, has come or not (step S2). When the collection timing has not come (step S2: negative), the frame counting units 51 and 52 perform the process in step S1.

On the other hand, when the collection timing has come (step S2: positive), the frame count collecting unit 9 collects the frame counter value, registers the frame count value to the counter management table, and registers the determination result of the transmission state to the priority path determination table 103 (step S3).

Then, the fragment control unit 8 decides the priority-path state of each path by referring to the priority path determination table 103 and the fragment state management table 101 (step S4).

The fragment control unit 8 then decides the fragment control method for the transmission IFs 71 and 72 by using the fragment state management table 101 (step S5).

The fragment control unit 8 then decides the fragment control state of each path by using the fragment state management table 101, and issues the instruction of setting or canceling the fragment process to the fragment processing units 31 and 32 by using the path connection management table 102 (step S6).

The fragment processing units 31 and 32 execute the fragment process for each path, i.e., for each VLAN, according to the instruction from the fragment control unit (step S7).

The collection of the frame counter value and the determination of the transmission state of the frame will next be described with reference to FIG. 8. The flowchart in FIG. 8 illustrates the process in step S3 in FIG. 7 in detail.

The frame count collecting unit 9 acquires the frame counter value from the frame counting units 51 and 52 (step S101).

The frame count collecting unit 9 then registers the collected frame counter values to the counter management table 104 so as to update the counter management table (step S102).

The frame count collecting unit 9 selects one of the paths to which the determination of the transmission state of the frame is not finished (step S103).

The frame count collecting unit 9 determines whether or not the selected path satisfies the condition that the number of the short frames is not less than the threshold value and the number of the long frames is 0 (step S104).

When the selected path satisfies the condition (step S104: positive), the frame count collecting unit 9 sets the determination result of the transmission state of the selected path as “TRUE” in the priority path determination table 103 (step S105). On the other hand, when the selected path does not satisfy the condition (step S104: negative), the frame count collecting unit 9 sets the determination result of the transmission state of the selected path as “FALSE” in the priority path determination table 103 (step S106).

The frame count collecting unit 9 determines whether the determination of the transmission state of the frame for all paths is completed or not (step S107). When there is the path to which the determination is not executed (step S107: negative), the frame count collecting unit 9 returns to step S103. On the other hand, when the determination for all paths is completed (step S107: positive), the frame count collecting unit 9 requests the control of the fragment process to the fragment control unit 8 (step S108).

The flow of determining the priority-path state will be described with reference to FIG. 9. The flowchart in FIG. 9 illustrates one example of the process in step S4 in FIG. 7 in detail.

When receiving the request of the fragment control from the frame count collecting unit 9, the fragment control unit 8 selects any one of all paths. The fragment control unit 8 then determines whether the fragment control state is currently executed or not in the selected path from the fragment control state in the fragment state management table 101 (step S201).

When the fragment control state indicates that the fragment control is currently executed in the selected path (step S201: positive), the fragment control unit 8 sets the priority-path state in this cycle as the non-priority path in the fragment state management table 101 (step S202), and then, proceeds to step S210.

On the other hand, when the fragment control state is not currently executed in the selected path (step S201: negative), the fragment control unit 8 determines whether the determination result of the transmission state of the selected path is TRUE or not from the priority path determination table 103 (step S203). When the determination result of the transmission state of the selected path is TRUE (step S203: positive), the fragment control unit 8 sets the priority-path state of the selected path in this cycle as the priority path (step S204), and proceeds to step S210.

On the other hand, when the determination result of the transmission state of the selected path is FALSE (step S203: negative), the fragment control unit 8 determines whether the priority-path state of the selected path in the previous cycle is the priority path or not (step S205). When the priority-path state in the previous cycle is not the priority path (step S205: negative), the fragment control unit 8 determines whether the priority-path state of the selected path in the previous cycle is the non-priority path or not (step S206).

When the priority-path in the previous cycle is the non-priority path (step S206: positive), the fragment control unit 8 sets the priority-path state of the selected path in this cycle as the non-priority path (step S207), and then, proceeds to step S210.

On the other hand, when the priority-path state in the previous cycle is the currently-protected path (step S206: negative), the fragment control unit 8 determines whether the value of the fragment cancel protection of the selected path in the fragment state management table 101 is 0 or not (step S208). When the value of the fragment cancel protection is 0 (step S208: positive), the fragment control unit 8 sets the priority-path state of the selected path in this cycle as the non-priority path (step S209).

Then, the fragment control unit 8 sets the value of the fragment cancel protection to 0 (step S210) after step S202, step S204, step S207, or step S209.

On the other hand, when the value of the fragment cancel protection is not 0 (step S208: negative), the fragment control unit 8 sets the priority-path state of the selected path in this cycle as the currently-protected path (step S211). Then, the fragment control unit 8 decrements the value of the fragment cancel protection by 1 (step S212).

On the other hand, when the priority-path state in the previous cycle is the priority path (step S205: positive), the fragment control unit 8 sets the priority-path state of the selected path in this cycle as the currently-protected path (step S213). Then, the fragment control unit 8 sets the value of the fragment cancel protection to the number of protection set beforehand (step S214).

The fragment control unit 8 registers the decided priority-path state and the value of the fragment cancel protection of the selected path to the fragment state management table 101. The fragment control unit 8 then determines whether the determination of the priority-path state and the decision of the value of the fragment cancel protection are made for all paths or not (step S215). When the path to which these processes are not executed remains (step S215: negative), the fragment control unit 8 returns to step S201. On the other hand, when these processes are completed for all paths (step S215: positive), the fragment control unit 8 ends the process of determining the priority-path state and of deciding the value of the fragment cancel protection.

In this flow, the priority-path state and the fragment cancel protection state are set each time. However, when the value is the same as the previous value, the fragment control unit 8 may keep the priority-path state and the value of the fragment cancel protection of the selected path.

The flow of deciding the fragment control method will next be described with reference to FIG. 10. The flowchart in FIG. 10 illustrates one example of the process in step S5 in FIG. 7 in detail. The decision of the fragment control method for the transmission IF 71 will be described below as an example.

The fragment control unit 8 temporarily sets the fragment control method for the transmission IF 71 as “cancel” (step S301).

Then, the fragment control unit 8 selects one of the paths using the transmission IF 71. The fragment control unit 8 determines whether the priority-path state of the selected path is the priority path or not by referring to the current priority-path state in the fragment state management table 101 (step S302). When the selected path is the priority path (step S302: positive), the fragment control unit 8 sets the fragment control method for the transmission IF 71 as “set” (step S303). In this case, the fragment control unit 8 decides the fragment control method for the transmission IF 71 as “set”, and ends the process of deciding the fragment control method.

On the other hand, when the selected path is not the priority path (step S302: negative), the fragment control unit 8 determines whether the priority-state of the selected path is the currently-protected path or not (step S304). When the selected path is the currently-protected path (step S304: positive), the fragment control unit 8 sets the fragment control method for the transmission IF 71 as “hold” (step S305).

On the other hand, when the selected path is not the currently-protected path, i.e., when it is the non-priority state (step S304: negative), the fragment control unit 8 keeps the fragment control method for the transmission IF 71 as “cancel”, and then, proceeds to step S306.

Then, the fragment control unit 8 determines whether the determination of the fragment control method is completed for all paths or not (step S306). When the path to which the determination is not executed remains (step S306: negative), the fragment control unit 8 returns to step S302. On the other hand, when the determination is completed for all paths (step S306: positive), the fragment control unit 8 ends the process of deciding the fragment control method.

The flow of deciding the fragment control state will be next described with reference to FIG. 11. The flowchart in FIG. 11 illustrates the process in step S6 in FIG. 7 in detail. The decision of the fragment control state for the path using the transmission IF 71 will be described below as an example.

The fragment control unit 8 determines whether the fragment control method for the transmission IF 71 is “hold” or not (step S401). When the fragment control method for the transmission IF 71 is “hold” (step S401: positive), the fragment control unit 8 keeps the fragment control state of the process corresponding to the connection-source ID and executed by the fragment processing units 31 and 32, and ends the process of deciding the fragment control state.

On the other hand, when the fragment control method for the transmission IF 71 is not “hold” (step S401: negative), the fragment control unit 8 determines whether the fragment control method for the transmission IF 71 is “set” or not (step S402).

When the fragment control state is “set” (step S402: positive), the fragment control unit 8 selects one of the paths for which the fragment control state is not decided and which uses the transmission IF 71 (step S403). The fragment control unit 8 determines whether the priority-path is the non-priority path or not by referring to the fragment state management table 101 (step S404). When the selected path is not the non-priority path, i.e., when the selected path is the priority path or the currently-protected path (step S404: negative), the fragment control unit 8 keeps the fragment control state in the process executed by the fragment processing unit 31 or 32 corresponding to the connection-source ID of the selected path, and then, proceeds to step S407. On the other hand, when the selected path is the non-priority path (step S404: positive), the fragment control unit 8 issues the instruction of setting the fragment process to the process corresponding to the connection-source ID of the selected path to the fragment processing unit 31 or 32 (step S405). The fragment control unit 8 also sets the fragment control state of the selected path in the fragment state management table 101 as “currently executed” (step S406). The fragment control unit 8 determines whether the decision of the fragment control state for all paths using the transmission IF 71 is completed or not (step S407). When the path to which the fragment control state is not decided remains (step S407: negative), the fragment control unit 8 returns to step S403.

When the fragment control method of the transmission IF 71 is not “set”, i.e., when it is “cancel” (step S402: negative), the fragment control unit 8 selects one of the paths for which the fragment control state is not decided and which uses the transmission IF 71 (step S408). The fragment control unit 8 then acquires the fragment control state of the selected path from the fragment state management table 101, and determines whether the fragment process is currently executed or not in the selected path (step S409). When the fragment process is not executed in the selected path (step S409: negative), the fragment control unit 8 keeps the fragment control state of the process executed by the fragment processing unit 31 or 32 corresponding to the connection-source ID of the selected path, and then, proceeds to step S412. On the other hand, when the fragment process is currently executed in the selected path (step S409: positive), the fragment control unit 8 issues an instruction of canceling the fragment process in the process corresponding to the connection-source ID of the selected path to the fragment processing unit 31 or 32 (step S410). The fragment control unit 8 also sets the fragment control state of the selected path in the fragment state management table 101 as “not executed” (step S411). The fragment control unit 8 determines whether the decision of the fragment control state for all paths using the transmission IF 71 is completed or not (step S412). When the path to which the fragment control state is not decided remains (step S412: negative), the fragment control unit 8 returns to step S408.

When the decision of the fragment control state is made for all paths using the transmission IF 71 (step S407 or step S412: positive), the fragment control unit 8 ends the process of deciding the fragment control state.

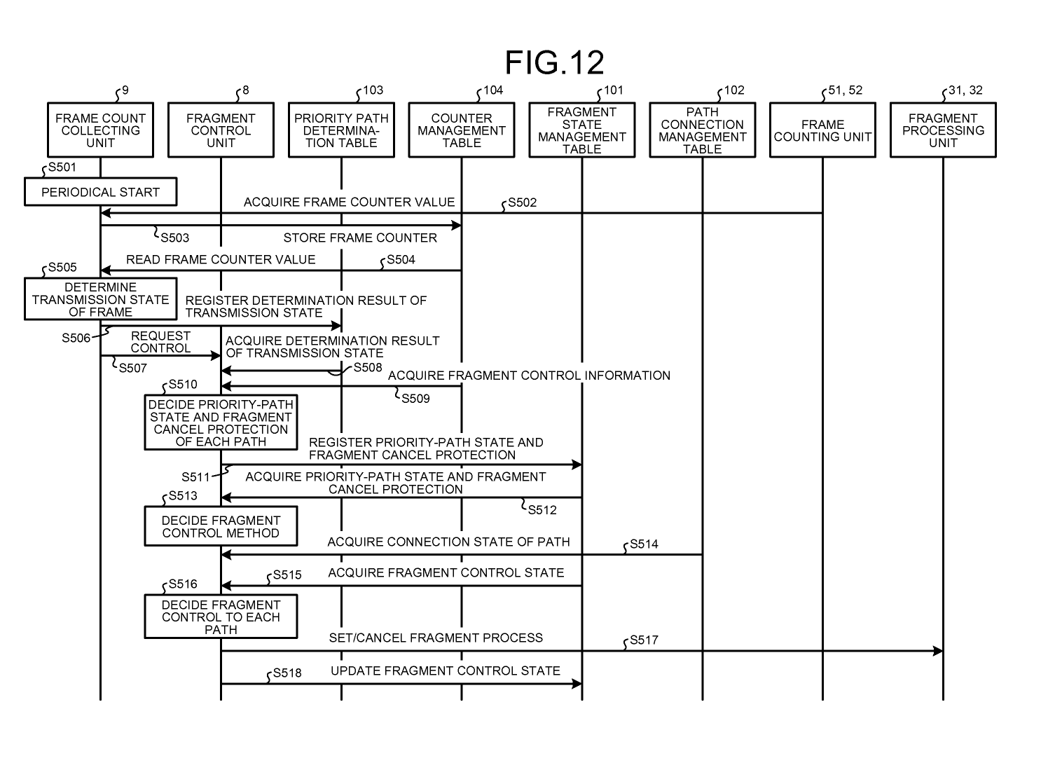

The control of the fragment process by the data transmission apparatus according to the present embodiment will next be described with reference to FIG. 12. FIG. 12 is a sequence diagram of the control of the fragment process by the data transmission apparatus according to the first embodiment.

The frame count collecting unit 9 periodically starts when the collection timing of the frame count value has come (step S501).

The frame count collecting unit 9 acquires the frame counter value from the frame counting units 51 and 52 (step S502).

The frame count collecting unit 9 then stores the collected frame counter values to the counter management table 104 (step S503).

The frame count collecting unit 9 then reads the frame counter value of each path from the counter management table 104 (step S504).

Then, the frame count collecting unit 9 determines the transmission state of the frame in each path (step S505). The frame count collecting unit 9 registers the determination result of the transmission state of each path to the priority path determination table 103 (step S506).

The frame count collecting unit 9 requests the control of the fragment process to the fragment control unit 8 (step S507).

The fragment control unit 8 acquires the determination result of the transmission state from the priority path determination table 103 (step S508). The fragment control unit 8 also acquires fragment control information from the counter management table 104 (step S509).

Then, the fragment control unit 8 decides the priority-path state and the fragment cancel protection of each path (step S510). The fragment control unit 8 registers the decided priority-path state and the fragment cancel protection of the selected path to the fragment state management table 101 (step S511).

Next, the fragment control unit 8 acquires the priority-path state and the fragment cancel protection of each path from the fragment state management table 101 (step S512).

The fragment control unit 8 then decides the fragment control method for each of the transmission IFs 71 and 72 (step S513).

Then, the fragment control unit 8 acquires the connection state indicating the correspondence between the connection source and the connection destination of each path from the path connection management table 102 (step S514). The fragment control unit 8 also acquires the fragment control state of each path from the fragment state management table 101 (step S515).

The fragment control unit 8 decides the fragment control of setting or canceling the fragment process to each path (step S516).

Thereafter, the fragment control unit 8 issues the instruction of setting or canceling the fragment process to each path to the fragment processing units 31 and 32 (step S517). The fragment control unit 8 also registers the current fragment control state of each path to the fragment state management table 101 to update the frame to the table (step S518).

In the present embodiment, the currently-protected path is used as one of the priority-path states. However, it can be set such that the currently-protected path is not used, if a fixed period is not necessarily set for the changeover from the priority path to the non-priority path.

### Hardware Structure

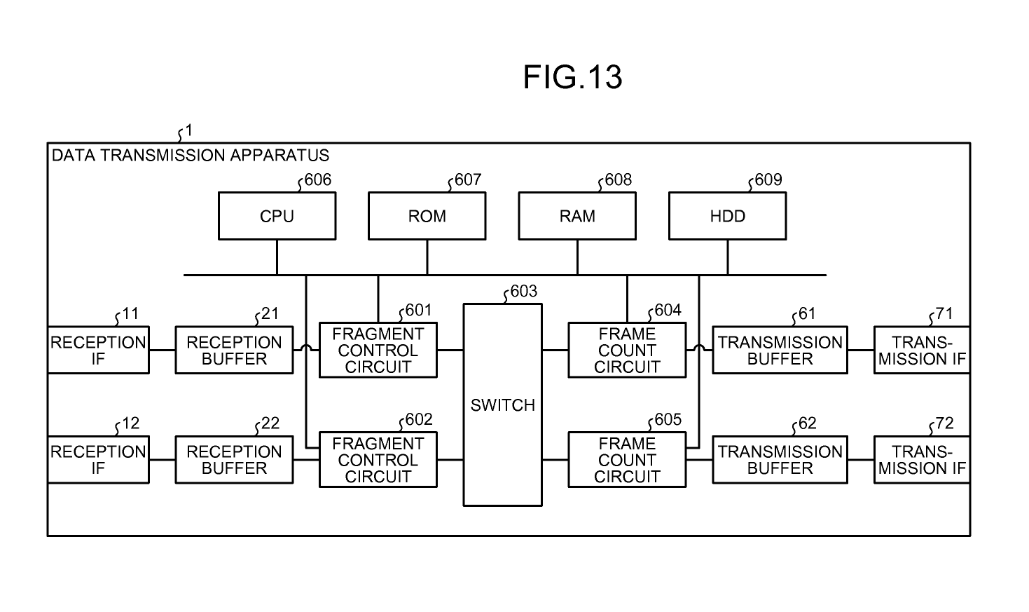

FIG. 13 is a diagram illustrating a hardware structure of the data transmission apparatus. The data transmission apparatus 1 includes reception IFs 11 and 12, reception buffers 21 and 22, fragment control circuits 601 and 602, a switch 603, frame count circuits 604 and 605, transmission buffers 61 and 62, and transmission IFs 71 and 72. The data transmission apparatus 1 also includes a CPU (Central Processing Unit) 606, a ROM (Read Only Memory) 607, a RAM (Random Access Memory) 608, and HDD (Hard Disk Drive) 609.

The fragment control circuits 601 and 602, the frame count circuits 604 and 605, the CPU 606, the ROM 607, the RAM 608, and the HDD 609 are connected with a bus.

The fragment control circuits 601 and 602 realize the function of the fragment processing units 31 and 32 illustrated in FIG. 1.

The frame count circuits 604 and 605 realize the function of the frame counting units 51 and 52 illustrated in FIG. 1.

The CPU 606, the ROM 607, the RAM 608, and the HDD 609 realize the function of the fragment control unit 8, the frame count collecting unit 9, and the like illustrated in FIG. 1.

Specifically, the ROM 607 stores various programs, such as a program of realizing the function of the fragment control unit 8 and the frame count collecting unit 9 illustrated in FIG. 1. The RAM 608 stores, for example, data for communication connection and data of the frame count value counted by the frame count circuits. The HDD 609 stores the fragment state management table 101, the path connection management table 102, the priority path determination table 103, and the counter management table 104. The HDD 609 also has a table for the communication connection.

The CPU 606 reads and executes various programs from the ROM 607, so as to generate a process realizing the respective functions described above.

As described above, when there is a path through which only the short frames flow in the number not less than the threshold value, the data transmission apparatus according to the present embodiment sets this path as the priority path, and executes the fragment process to the long frame in the other path using the transmission interface same as that for the priority path. Thus, the delay of the short frame can be reduced, while preventing the use of the additional band.

Since a certain time is set until the fragment process is canceled by using the currently-protected path, the frequency of changing the process of setting the fragment process and the process of canceling the fragment process can be reduced. Accordingly, the processing load can be reduced, and the delay of the short frame can be reduced more.

### [b] Second Embodiment

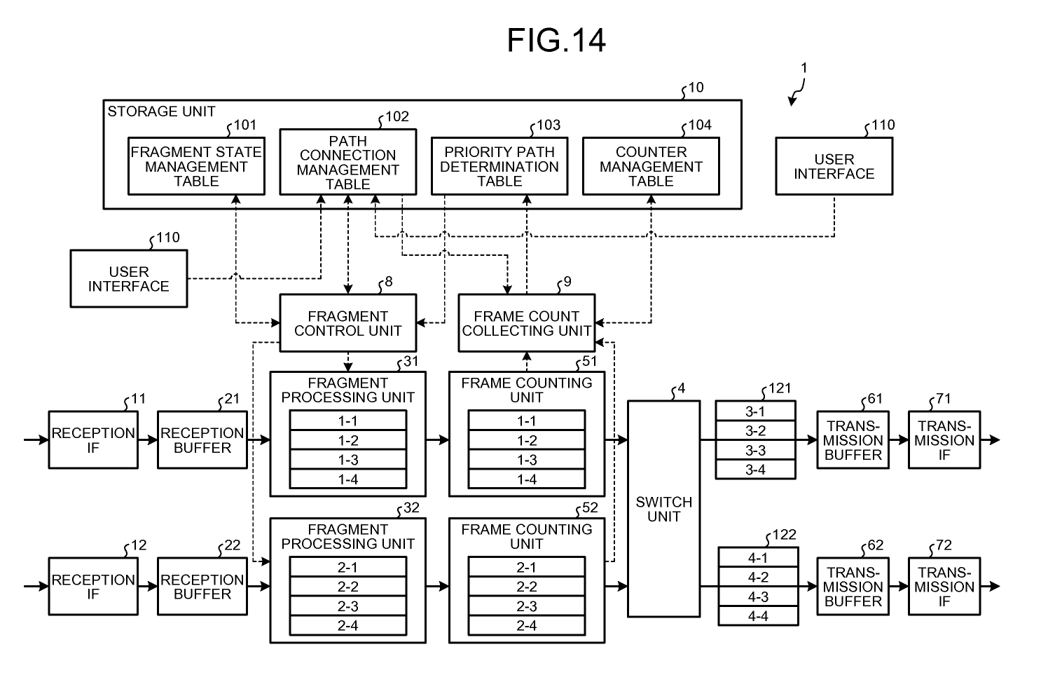

FIG. 14 is a block diagram illustrating a data transmission apparatus according to a second embodiment. A data transmission apparatus 1 according to the present embodiment is different from the first embodiment in that it counts a frame for each reception interface. The functions same as those in the first embodiment will not be repeated in the description below.

The frame counting unit 51 counts the number of the frames received from the fragment processing unit 31 for each connection-source ID. The frame counting unit 52 counts the number of the frames received from the fragment processing unit 32 for each connection-source ID.

FIG. 14 illustrates the connection-destination ID of each path on the communication route as connection-destination IDs 121 and 122, in order to indicate that the frame flows through each path in an easily understood manner. It is allowable that the function unit having the connection-destination ID actually be not arranged.

The frame count collection unit 9 periodically acquires the frame count value from the frame counting units 51 and 52. The frame count collecting unit 9 then registers the frame count value to the counter management table 104 for each connection-source ID. The frame count collecting unit 9 also acquires the determination result of the transmission state of each path for each connection-source ID by referring to the counter management table 104. The frame count collecting unit 9 also acquires the correspondence between the connection-source ID and the connection-destination ID from the path connection management table 102, and allows the correspondence to be associated with the determination result of the transmission state of each path for each connection-destination ID and each connection-source ID. The frame count collecting unit 9 registers the determination result of the transmission state to the priority path determination table 103 for each connection-destination ID of the path.

As described above, the data transmission apparatus according to the present embodiment acquires the frame count value of each path for each reception interface, and executes the fragment control based upon this value. Since the place for arranging the frame count circuit is flexible, the frame count circuit can be designed in accordance with the arrangement state of each unit.

One aspect of the data transmission apparatus and data transmission method described in the present invention provides an effect of being capable of preventing the delay in the short frame, while preventing the use of the additional band.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data transmission apparatus comprising:
a reception unit that receives a frame from a transmission source;
an output unit that outputs the frame received from the transmission source;
a frame counting unit that counts a frame having a size not more than a predetermined value out of the frames output from the output unit for each transmission source; and
a fragment control unit that, when a transmission source from which a predetermined number of frames having the size not more than the predetermined value are continuously counted is present, fragments a frame having a size larger than the predetermined value from other transmission source than the transmission source, and outputs the fragmented frame from the output unit.

2. The data transmission apparatus according to claim 1, wherein, when the transmission source from which the predetermined number of frames having the size not more than the predetermined value are continuously counted is not present, the fragment control unit allows the frame having the size larger than the predetermined value from the other transmission source to be output from the output unit.

3. The data transmission apparatus according to claim 1, wherein
the reception unit receives a frame from the transmission source which is included in a predetermined section;
the frame counting unit counts the frame for each of the predetermined sections; and
the fragment control unit, when a specific section from which the predetermined number of frames having the size not more than the predetermined value are continuously counted is present, fragments the frame having the size larger than the predetermined value from the other transmission source belonging to other section than the specific section, and outputs the fragmented frame from the output unit.

4. The data transmission apparatus according to claim 1, wherein
the output unit is provided in a plurality of numbers;
the frame counting unit counts the frame having the size not more than the predetermined value for each of the output units; and
the fragment control unit, when the transmission source from which the predetermined number of frames having the size not more than the predetermined value are continuously counted is present for a specific output unit, fragments the frame that is from the other transmission source, is output from the specific output unit, and has the size larger than the predetermined value.

5. The data transmission apparatus according to claim 1, wherein, when fragmenting the frame from the other transmission source, the fragment control unit cancels the fragment process to the frame from the other transmission source on stopping receiving the frame having the size not more than the predetermined value or receiving the frame having the size larger than the predetermined value from the transmission source from which the predetermined number of frames having the size not more than the predetermined value are continuously counted.

6. The data transmission apparatus according to claim 5, wherein, when canceling the fragment process to the frame from the other transmission source, the fragment control unit executes the fragment process for a certain period after stopping receiving of the frame having the size not more than the predetermined value or receiving of the frame having the size larger than the predetermined value from the transmission source from which the predetermined number of frames having the size not more than the predetermined value are continuously counted, and then, cancels the fragment process.

7. A data transmission method comprising:
receiving a frame from a transmission source;
counting a number of frames that are output from an output port and have a size not more than a predetermined value for each transmission source; and
when a transmission source from which a predetermined number of frames having the size not more than the predetermined value are continuously counted is present, fragmenting a frame having a size larger than the predetermined value from other transmission source than the transmission source; and outputting the fragmented frame from the output port.
